(19) United States
(12) Patent Application Publication
(10) Pub. No.: US 2014/0261466 A1
(43) Pub. Date: Sep. 18, 2014

(54) ADSORBENT, METHOD FOR PRODUCING SAME, ADSORBENT FOR WATER PURIFICATION, MASK AND ADSORPTIVE SHEET

(71) Applicant: SONY CORPORATION, Tokyo (JP)

(72) Inventors: Shun Yamanoi, Kanagawa (JP); Hironori Iida, Kanagawa (JP); Seiichiro Tabata, Kanagawa (JP); Machiko Minatoya, Tokyo (JP); Shinichiro Yamada, Kanagawa (JP)

(21) Appl. No.: 14/349,617

(22) PCT Filed: Oct. 2, 2012
(86) PCT No.: PCT/JP2012/075511

§ 371 Date: Apr. 3, 2014

(30) Foreign Application Priority Data
Oct. 12, 2011 (JP) 2011-224481

(51) Int. Cl. B01J 20/32; B01J 20/10; C02F 1/28; A41D 13/11; A62B 23/02

(52) U.S. Cl. CPC B01J 20/3234; A41D 13/11; A62B 23/025; C02F 1/288; C02F 1/281; B01J 20/103
USPC 128/863; 502/407; 502/408; 252/176

(57) ABSTRACT

Provided is an absorbent including silica of which a raw material is a material originating from a plant which includes silicon, and a silane coupling agent which modifies a surface of the silica. A value of a specific surface area of the silica in accordance with a nitrogen BET method is 10 m²/g or more, and a pore volume of the silica in accordance with a BJH method is 0.1 cm³/g or more.

### TECHNICAL FIELD

The present disclosure relates to an adsorbent, a method of preparing the same, an adsorbent for water purification, a mask and an adsorbing sheet.

### BACKGROUND ART

In order to remove a heavy metal such as chromium (Cr) from water, ion exchange resin, chelate resin and zeolite are used in the past (refer to, for example, JP H09-187646A, JP 2003-137536A and JP H04-292412A). In order to remove organics from water, silica gel are used in the past (JP H11-099331A).

### CITATION LIST

### Patent Literature

Patent Literature 1: JP H09-187646A

Patent Literature 2: JP 2003-137536A

Patent Literature 3: JP H04-292412A

Patent Literature 4: JP H11-099331A

### SUMMARY OF INVENTION

### Technical Problem

However, the ion exchange resin, the chelate resin and the zeolite are expensive, and a less expensive and high performance adsorbent is strongly demanded. While the silica gel is problematic because it cannot adsorb a larger organic molecule, a material is demanded which can adsorb a larger molecule.

Accordingly, an object of the present disclosure is to provide a less expensive and high performance adsorbent, a method of preparing the same, an adsorbent for water purification, a mask and an adsorbing sheet by using the above absorbent.

### Solution to Problem

The adsorbent in accordance with a first embodiment of the present disclosure for achieving the above object includes:

silica of which a raw material is a material originating from a plant which includes silicon; and

a silane coupling agent which modifies a surface of the silica,

wherein a value of a specific surface area of the silica in accordance with a nitrogen BET method is 10 m²/g or more, and a pore volume of the silica in accordance with a BJH method is 0.1 cm³/g or more, and preferably 0.2 cm³/g or more.

The adsorbent in accordance with a second embodiment of the present disclosure for achieving the above object includes:

silica of which a raw material is a material originating from a plant which includes silicon; and

a silane coupling agent which modifies a surface of the silica,

wherein a value of a specific surface area of the silica in accordance with a nitrogen BET method is 10 m²/g or more, and, in pore size distribution of the silica obtained by using a non-localized density functional theory method (NLDFT method), a total of volumes of pores each having a pore size ranging from 1 nm to 25 nm is 0.1 cm³/g or more, and a ratio of a total of volumes of pores each having a pore size ranging from 5 nm to 25 nm to the total of volumes of the pores each having the pore size ranging from 1 nm to 25 nm is 0.2 or more, preferably 0.5 or more, and more preferably 0.7 or more.

A method of preparing the adsorbent of the first embodiment of the present disclosure for achieving the above object is a method of preparing an adsorbent in which a value of a specific surface area of silica in accordance with a nitrogen BET method is 10 m²/g or more, and a pore volume of the silica in accordance with a BJH method is 0.1 cm³/g or more, and preferably 0.2 cm³/g or more, the method including, in the sequence set forth:

obtaining the silica by sintering a material originating from a plant which includes silicon; and

modifying a surface of the silica with a silane coupling agent.

A method of preparing the adsorbent of the second embodiment of the present disclosure for achieving the above object is a method of preparing an adsorbent in which a value of a specific surface area of silica in accordance with a nitrogen BET method is 10 m²/g or more, and, in pore size distribution of the silica obtained by using a non-localized density functional theory method, a total of volumes of pores each having a pore size ranging from 1 nm to 25 nm is 0.1 cm³/g or more, and a ratio of a total of volumes of pores each having a pore size ranging from 5 nm to 25 nm to the total of volumes of the pores each having the pore size ranging from 1 nm to 25 nm is 0.2 or more, preferably 0.5 or more, and more preferably 0.7 or more, the method including, in the sequence set forth:

obtaining the silica by sintering a material originating from a plant which includes silicon; and

modifying a surface of the silica with a silane coupling agent.

The adsorbent for the water purification of the present disclosure for achieving the above object includes the adsorbent in accordance with the first embodiment or the second embodiment of the present disclosure. The mask of the present disclosure for achieving the above object includes the adsorbent in accordance with the first embodiment or the second embodiment of the present disclosure. The adsorbing sheet of the present disclosure for achieving the above object includes a sheet-shaped member having the adsorbent in accordance with the first embodiment or the second embodiment of the present disclosure.

### Advantageous Effects of Invention

In the absorbent and the method of preparing the same, and the adsorbent for the water purification, the mask and the adsorbing sheet in accordance with the first embodiment or the second embodiment of the present disclosure, a preparation cost is low because the material originating from the plant and including the silicon is used as the raw material. The value of the specific surface area of the adsorbent, the value of the pore volume and the pore size distribution are specified, and further because the surface of the silane is modified with the silane coupling agent, the higher adsorbing ability is provided to the adsorbent.

### BRIEF DESCRIPTION OF DRAWINGS

FIG. 1 is a graph showing measurement results of the pore size distribution obtained based on the non localized density functional theory method in samples of the adsorbents of Example 1, Reference Example 1, Comparative Example 1A and Comparative Example 1B.

FIG. 2A and FIG. 2B are a schematic view of a mask of Example 3, and a view showing a main part of the mask, respectively.

FIG. 3 is a schematic sectional view of a water purifier in Example 4.

FIG. 4A and FIG. 4B are a schematic partial sectional view and a schematic sectional view, respectively, of a bottle in Example 4

FIG. 5A and FIG. 5B are a schematic partial sectional view and a schematic view a part of which is removed, respectively, of an alternative example of the bottle in Example 4.

### DESCRIPTION OF EMBODIMENTS

Although the present disclosure will be described based on Examples while referring to the drawings, the present disclosure is not restricted to these Examples, and various numerals and materials in Examples are exemplary. The description will be conducted according to the following order.

1. The adsorbent, the method of preparing the same, the adsorbent for water purification, the mask and the adsorbing sheet in accordance with the first embodiment and the second embodiment of the present disclosure, and the generic description
2. Example 1 (the adsorbent and the method of preparing the same in accordance with the first embodiment and the second embodiment of the present disclosure
3. Example 2 (the adsorbent for water purification, the mask and the adsorbing sheet of the present disclosure), an others
<The adsorbent, the method of preparing the same, the adsorbent for water purification, the mask and the adsorbing sheet in accordance with the first embodiment and the second embodiment of the present disclosure, and the generic description>

In the absorbent in accordance with the first embodiment or the second embodiment of the present disclosure, the adsorbent prepared by the method of preparing the adsorbent in accordance with the first embodiment or the second embodiment of the present disclosure, and the adsorbent of the present disclosure configuring the adsorbent for the water purification, the mask or the adsorbing sheet (these may be also hereinafter referred to as ‘adsorbent and the like’), the adsorbent and the like of the present disclosure can effectively adsorb organics (organic molecules) because the surface of the silane is modified with the silane coupling agent.

The absorbent and the like of the present disclosure may have a form that the silane coupling agent is treated with acid. The method of preparing the adsorbent of the present disclosure may have a form that after the surface of the silica is treated with the silane coupling agent, the silane coupling gent is treated with the acid. In these forms, the adsorbent and the like of the present disclosure can effectively adsorb, for example, a cation containing metal atom (for example, copper ion). The acid treatment herein refers to a treatment in which the adsorbent and the like of the present disclosure is dipped into an inorganic acid such as chloric acid, sulfuric acid, nitric acid and phosphoric acid. In these forms, the silane coupling agent preferably contains at its terminal a functional group which bonds to a desirable metal ion (including a metal atom). Or, after the silane coupling agent is treated with silane, the silane coupling agent is preferably provided with a functional group which bonds to a desirable metal ion (including a metal atom). The adsorbent and the like of the present disclosure of these forms can effectively adsorb an anion and a cation containing a metal atom [for example, an arsenic ion having a form of AsO₃⁻³, a chromium ion having a form of CrO₄⁻², and a lead ion having a form of Pb²⁺], a mercury ion contained in mercury chloride and methyl mercury. An amino group, a chelate ring in which a metal such as iron (Fe), cobalt (Co) and copper (Cu) is coordinated to an amino group and the like and a molecule containing sulfur (S) such as a thiol group can be exemplified as the functional group the silane coupling agent contains or the functional group provided to the silane coupling agent.

The absorbent of the present disclosure including the above preferable forms is an absorbent adsorbing organics (for example, an organic molecule and a protein) having a number average molecular weight of 1×10² or more, and as a target, an aliphatic acid (specifically, oleic acid, stearic acid, myristic acid, squalene and cholesterol, for example), a pigment (for example, Pigment Red 57:1), a toxin (microcystrine, aflatoxin B1, nodularin, anatoxin, saxitoxin and Cylindrospermopsin), a pesticide and an insecticide (for example, simazine, parathion, fenobucarb, Carbaryl and cyhalothrin), and a protein (alpha-amylase and neuraminidase) are exemplified.

In the absorbent and the like of the present disclosure including the various preferable forms described above, 3-aminopropylethoxysilane, methyltriethoxysilane, phenyltriethoxysilane, tetraethoxysilane, ethyltrioxysilane, aryltriethoxysilane, 3-[2-(2-aminoethylamino)ethylamino]propyltrimethoxysilane, 3-aminopropyldimethylmethoxysilane, 3-aminopropyltrimethoxysilane, octadecyltrimethoxysilane, (3-chloropropyl)trimethoxysilane, 3-glycidoxypropyltrimethoxysilane, 3-cyanopropyldimethylmethoxysilane, 3-heptafluoroisoprop oxypropyl trimethoxysilane, vinyltrimethoxysilane, 2-(3,4-epoxycyclohexyl)ethyltrimethoxysilane, 3-glycidoxypropylmethyldimethoxysilane, 3-glycidoxypropyltrimethoxysilane, 3-glycidoxypropyltrimethoxysilane, 3-glycidoxypropylmethyldimethoxysilane, 3-glycidoxypropyltriethoxysilane, N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, 3-ureidopropyltriethoxysilane, 3-mercaptopropylmethyldimethoxysilane, 3-mercaptopropyltrimethoxysilane, bis(triethoxysilylpropyl)tetrasulfide and 3-isocyanatepropyltriethoxysilane are specifically exemplified.

In the adsorbent and the like of the present disclosure including the various preferable forms described above, the material originating from the plant and containing the silicon is used as the raw material of the silica, and specifically, as the material originating from the plant, chaff of rice (rice plant), barley, wheat, rye, Japanese millet and foxtail millet, straw, coffee beans, tea leaves (for example, leaves of green tea and red tea), sugar canes (for example, bagasse), corns (for example, cores of corns), fruit peels (for example, peels of mandarin oranges and bananas) or reed and “kuki wakame” (sliced seaweed stem) are exemplified and are not restricted, and further, a vascular bundle plant which is vegetative on land, a pteridophyte, a bryophyte, algae and seagrass are exemplified. These materials may be used singly as the raw material, or a plurality of species can be mixed and used.

The shape and the form of the material originating from the plant are not especially restricted and, for example, the chaff and the straw can be used without modification, or those dry-treated may be used. Further, those subjected to various treatments such as a fermentation treatment, a roasting treatment and an extraction treatment during the processing of food and drink such as beer and liquor can be used. In view of the recycling industrial wastes, the straw and the chaff after the processing such as thrashing can be preferably used. The straw and the chaff after the processing can be easily obtained in large quantities, for example, at a farmer's cooperative, a distillery, a food company and a food processing company.

In the method of preparing the adsorbent of the present disclosure, the silica can be obtained by calcining the material originating from the plant and containing the silicon, for example, at 200 degree C. in air. A desired grain size can be obtained by pulverizing the material originating from the plant depending on necessity and the material can be classified. The material originating from the plant can be washed in advance. A desired grain size can be obtained by pulverizing the obtained silica depending on necessity and the silica can be classified. Further, the silica finally obtained can be subjected to a disinfection treatment. A form, a configuration and a structure of a furnace for the calcination are free of restriction, and a continuous furnace or a butch furnace can be used.

In the adsorbing sheet of the present disclosure including the above preferable forms, a woven fabric and a non-woven fabric are exemplified as a support member, and cellulose, polypropylene and polyester are exemplified as a material configuring the support member. The forms of the adsorbing sheet include a form in which the adsorbent of the present disclosure is sandwiched between the support member and the support member, and a form in which the adsorbent is kneaded into the support member. The forms of the adsorbing sheet further include a form in which the adsorbent of the present disclosure/a polymer composite is sandwiched between the support member and the support member, and a form in which the adsorbent of the present disclosure/the polymer composite is kneaded into the support member. For example, carboxynitro cellulose is exemplified as the material configuring the adsorbent/the polymer composite (polymer).

The adsorbent of the present disclosure can be used, for example, for purification of water or purification of air, and purification of fluid in a broader sense. The forms of usage of the adsorbent of the present disclosure include, for example, use as a sheet-shaped, use in a state filled in a column and a cartridge, use in a state the adsorbent is shaped to a desired shape by using a binding agent (binder) and use in a powder state. For use as a depurative and an adsorbent dispersed in a solution, it is used after the surface is treated hydrophilically or hydrophobically. For example, a filter of an air purifying apparatus, a mask, protective gloves and protective shoes can be configured by the adsorbing sheet of the present disclosure.

The adsorbent and the like of the present disclosure or the silica which is a starting material of the adsorbent and the like of the present disclosure include a plenty of pores. The pores are generally classified into “mesopores” having a pore size from 2 nm to 50 nm, “macropores” having a pore size exceeding 50 nm, and “micropores” having a pore size smaller than 2 nm. While the pore volume in accordance with the BJH method is 0.1 cm³/g or more in the adsorbent and the like of the present disclosure, it is preferably 0.1 cm³/g or more as mentioned earlier.

The value of the specific surface area in accordance with the nitrogen BET method (hereinafter sometimes simply referred to as “the value of the specific surface area”) in the adsorbent and the like of the present disclosure is preferably and desirably 50 m²/g or more for obtaining further excellent functionalities.

The nitrogen BET method refers to a method in which an adsorption isotherm is measured by adsorbing and desorbing nitrogen as an adsorption molecule to and from an adsorbent (herein, adsorbent and the like of the present disclosure) and analyzing the measured data in accordance with a BET equation represented by Equation (1), and a specific surface area and a pore volume can be calculated based on the above method. Specifically, in case of calculating the value of the specific surface area in accordance with the nitrogen BET method, the adsorption isotherm is obtained at first by adsorbing and desorbing the nitrogen as the adsorption molecule to and from the adsorbent and the like of the present disclosure. Then, [p/{Vₐ(p₀−p)}] is calculated based on Equation (1) or Equation (1′) obtained by transforming Equation (1) from the adsorption isotherm obtained, and is plotted with regard to an equilibrium relative pressure (p/p₀). Then, the plot is regarded as a straight line, and a slant ‘s’ (=[(C−1)/(C·Vₘ)] and an intercept ‘i’ (=[1/(C·Vₘ)]1 are calculated based on a least-square approach. Then, Vₘ and ‘C’ are calculated from the slant ‘s’ and the intercept T based on Equation (2-1) and Equation (2-2). Further, the specific surface area a_{sBET} is calculated from Vₘ based on Equation (3) (refer to page 62 to page 66, a manual of analysis software of BELSORP-mini and BELSORP available from Bell Japan Inc.). This nitrogen BET method is a measurement method which is compliant with JIS R 1626-1996 “Measuring methods for the specific surface area of fine ceramic powders by gas adsorption using the BET method”.

Vₐ=(Vₘ·C·p)/[p₀−p){1+(C−1)(p/p₀)}] (1)

[p/{Vₐ(p₀−p)}]=(C−1)/(C−Vₘ)](p/p₀)+[1/(C−Vₘ)] (1′)

Vₘ=1/(s+i) (2-1)

C=(s/i)+1 (2-2)

a_{sBET}=(Vₘ·L·σ)/22414 (3)

Symbols are as stated below.

Vₐ: amount of adsorption
Vₘ: amount of adsorption of single molecular layer
p: pressure of nitrogen at equilibrium
p₀: pressure of nitrogen at saturation
L: Avogadro number
σ: adsorption sectional area of nitrogen

In case of calculating the pore volume Vₚ in accordance with the nitrogen BET method, for example, the adsorption data of the adsorption isotherm obtained is linear-interpolated, and an amount of adsorption ‘V’ is obtained at the relative pressure established as the relative pressure for calculating the pore volume. The pore volume Vₚ can be calculated from the amount of adsorption ‘V’ based on Equation (4) (refer to page 62 to page 65 of the manual of analysis software of BELSORP-mini and BELSORP available from Bell Japan Inc.). Hereinafter, the pore volume in accordance with the nitrogen BET method will be sometimes referred to as simply “pore volume”.

Vₚ=(V/2241)×(M_{g}/σ_{g}) (4)

Symbols are as stated below.

V: amount of adsorption at relative pressure
M_{g}: molecular weight of nitrogen
σ_{g}: density of nitrogen

The pore size of the mesopore can be, for example, calculated as pore distribution from a pore volume change rate based on the BJH method. The BJH method is a method widely used as a method for analyzing pore size distribution. In case of analyzing the pore volume distribution in accordance with the BJH method, a desorption isotherm is at first measured by adsorbing and desorbing nitrogen as an adsorption molecule to and from the adsorbent of the present disclosure. Then, based on the obtained desorption isotherm, a thickness of an adsorption layer between a state in which the pore is filled with an adsorption molecules (for example, nitrogen) and a state in which the adsorption molecules desorb stepwise, and an inner diameter of the pores (twice core radius) generated on this occasion are measured, a pore radius rₚ is calculated based on Equation (5), and the pore volume is calculated based on Equation (6). Then, a curve of pore size distribution can be obtained by plotting the pore volume change rate with respect to a pore diameter (2rₚ) from the pore radius and the pore volume (refer to page 85 to page 88 of the manual of analysis software of BELSORP-mini and BELSORP available from Bell Japan Inc.).

r=t+rₖ (5)

Vₚₙ=Rₙ·dVₙ−Rₙ·dtₙ·c·ΣAₚⱼ (6)

Note that:

Rn=rₚₙ²/(rₖₙ−1+dtₙ)² (7)

Symbols are as stated below.

rₚ: pore radius
rₖ: core radius (inner diameter/2) when absorption layer having thickness ‘t’ is adsorbed on inner wall of pore having pore radius rₚ at its pressure
Vₚₙ: pore volume when ‘n’th desorption of nitrogen takes place
dVₙ: amount of change on this occasion
dtₙ: amount of change of thickness tₙ of adsorption layer when ‘n’th desorption of nitrogen takes place
rₖₙ: core radius on this occasion
c: fixed value
rₚₙ: pore radius when ‘n’th desorption of nitrogen takes place

ΣAₚⱼ represents an integration value of a pore wall surface area from j=1 to j=n−1.

The pore size of the micropore can be calculated as the pore distribution from the pore volume change rate with respect to its pore size, for example, in accordance with the MP method. In case of analyzing the pore size distribution in accordance with the MP method, the adsorption isotherm is at first obtained by adsorbing nitrogen on the adsorbent and the like of the present disclosure. Then, this adsorption isotherm is converted into the pore volume with respect to the thickness ‘t’ of the adsorption layer (conducting T plot). Then, the curve of the pore size distribution can be obtained based on a curvature (an amount of change with respect to an amount of change of the thickness ‘t’ of the adsorption layer) of this plot (refer to page 72 to page 73 and page 82 of the manual of analysis software of BELSORP-mini and BELSORP available from Bell Japan Inc.).

In the non-localized density functional theory method (NLDFT method) prescribed in JIS Z8831-2:2010, “Pore size distribution and porosity of powdery materials (solid materials)—Part 2: Measurement method of mesopores and macropores by gas adsorption”, and JIS Z8831-3:2010, “Pore size distribution and pore characteristics of powdery materials (solid materials)—Part 3: Measurement method of micropores by gas adsorption”, a software appended to an apparatus for automatically measuring specific surface area/pore size distribution “BELSORP-MAX” available from Bell Japan Inc. is used as an analysis software. Precedent conditions are such that carbon black is assumed to be a model in the shape of cylinder, and a distribution function of a pore size distribution parameter is set to be “non-assumption”, and the distribution data obtained are subjected to smoothing ten times.

In the adsorbent and the like of the present disclosure, the specific surface area and the various pore volumes are measured in accordance with the nitrogen BET method for the silica after a thermal treatment at 120 degree C. for three hours under a reduced pressure.

### Example 1

Example 1 relates to an adsorbent in accordance with a first embodiment and a second embodiment of the present disclosure, and to a method of preparing the same. The adsorbent of Example 1 includes silica of which a raw material is a material originating from a plant which includes silicon, and a silane coupling agent of which a surface is modified. A value of a specific surface area of the silica in accordance with the nitrogen BET method is 10 m²/g or more, and the pore volume of the silica in accordance with the BJH method is 0.1 cm³/g or more, and preferably 0.2 cm³/g or more. The value of the specific surface area of the silica in accordance with the nitrogen BET method is 10 m²/g or more, and, in the pore size distribution of the silica obtained by using the non-localized density functional theory method (NLDFT method), the total of the volume of the pores having the pore size ranging from 1 nm to 25 nm is 0.1 cm³/g or more, and the ratio between the total of the volume of the pores having the pore size ranging from 5 nm to 25 nm and the total of the volume of the pores having the pore size ranging from 1 nm to 25 nm is 0.2 or more, preferably 0.5 or more, and more preferably 0.7 or more. The adsorbent of Example 1 effectively adsorbs the organics (organic molecules).

In Example 1, chaff of rice (rice plant) is used as the material originating from the plant and containing the silicon which is the raw material of the silica. In the method of preparing the adsorbent in Example 1, after the silica is obtained by calcining the material originating from the plant and containing the silicon, the surface of the silica is modified with the silane coupling agent. Hereinafter, the modification of the surface of the silica with the silane coupling agent will be sometimes referred to as “silane coupling treatment” for the sake of convenience.

In the preparation of the adsorbent of Example 1, the silica was at first obtained by calcining the chaff which was the material originating from the plant and containing the silicon, specifically, at 500 degree C. for three hours in an atmosphere.

This silica is referred to as “Reference Example 1”.

Then, 0.5 g of the silica of Reference Example 1 was added to 100 ml of toluene, further 5.0 g of 3-aminopropyltriethoxysilane was added, and agitation was conducted at 80 degree C. for five hours. After filtration for obtaining a solid phase, the adsorbent of Example 1 including the silica of which a surface was modified with the silane coupling agent was obtained by washing with 100 ml of toluene.

On the other hand, silica gel [tradename: Silica Gell, Small Granular (White)] available from Wako Kabushiki Kaisha was made to be “Comparative Example 1A”. A sample of “Comparative Example 1B” was obtained by modifying the surface of the silica gel of Comparative Example 1A with the silane coupling agent, similarly to Example 1.

The results of obtaining the pore size distribution of the samples of Example 1, Reference Example 1, Comparative Example 1A and Comparative Example 1B in accordance with the non-localized density functional theory method (NLDFT method) are shown in FIG. 1. The ratios between a total of a volume of pores having a pore size ranging from 5 nm to 25 nm and a total of a volume of pores having a pore size ranging from 1 nm to 25 nm were as shown in Table 1 below. In Table 1, the total of the volume of the pores having the pore size ranging from 1 nm to 25 nm is designated as “Volume-A” (unit: cm³/g), the total of the volume of the pores having the pore size ranging from 5 nm to 20 nm is designated as “Volume-B” (unit: cm³/g), and a ratio of Volume-B with respect to Volume-A is designated as “Ratio”. The results of measuring specific surface areas and pore volumes of these samples are shown in Table 2. In Table 2, ‘Specific Surface Area’ and ‘Total Pore Volume’ refer to the specific surface areas and the total pore volumes in accordance with the BJH method, and the units thereof are m²/g and cm³/g, respectively. “BJH method” and “MP method” show the results of volume measurement of the pores (mesopores to macropores) in accordance with the BJH method, and the results of volume measurement of the pores (micropores) in accordance with the MP method, respectively, and the units are cm³/g. In the measurements, the thermal treatment was conducted as a pretreatment to the samples at 120 degree C. for three hours under a reduced pressure.

TABLE 1

| | Volume-A | Volume-B | Ratio |
|---|---|---|---|
| Example 1 | 0.112 | 0.111 | 0.991 |
| Reference Example 1 | 0.232 | 0.228 | 0.983 |
| Comparative Example 1A | 0.391 | 0.010 | 0.026 |
| Comparative Example 1B | 0.000 | 0.000 | — |

TABLE 2

| | Specific | | | |
|---|---|---|---|---|
| | Surface | Total Pore | BJH | |
| | Area | Volume | method | MP method |
| Example 1 | 65 | 0.198 | 0.197 | 0.00 |
| Reference Example 1 | 106 | 0.294 | 0.271 | 0.02 |
| Comparative Example 1A | 702 | 0.403 | 0.138 | 0.39 |
| Comparative Example 1B | 6.5 | 0.013 | 0.001 | 0.002 |

As a result of analysis, in Example 1 in which the silane coupling treatment was conducted on Reference Example 1, while the specific surface areas, the total pore volumes and the values of the BJH method decreased, they were not so significant decrease. Only little change was recognized in “Ratio”. This is considered to be based on the peculiar pore shape (structure) of the silica. On the other hand, in Comparative Example 1B in which the silane coupling treatment was conducted on the silane of the Comparative Example 1A, the specific surface areas, the total pore volumes and the values of the BJH method largely decreased as a result of adsorption of the silane coupling agent on the surface.

After 10 mg of the respective samples of Example 1, Reference Example 1, Comparative Example 1A and Comparative Example 1B were taken and added to 40 ml of Alizarine Green aqueous solutions having concentration of 0.01 g/liter, they were agitated at 100 rpm for one hour. Thereafter, the results shown in Table 3 below were obtained as a result of the measurement of amounts of adsorption (mg) of the Alizarine Green per 1 g of the Alizarine Green aqueous solution based on a colorimeter method using an ultraviolet-visible spectrophotometer.

TABLE 3

| | |
|---|---|
| Example 1 | 20 mg |
| Reference Example 1 | 2 mg |
| Comparative Example 1A | 0 mg (detection limit or less) |
| Comparative Example 1B | 0 mg (detection limit or less) |

Since the material originating from the plant and containing the silicon is used as the raw material in the adsorbent of Example 1, preparation cost is low. Since the value of the specific surface area of the adsorbent, the value of the pore volume and the pore size distribution are prescribed, and the surface of the silica is modified with the silane coupling agent, the high adsorbing ability can be provided to the absorbent.

### Example 2

Example 2 is an alternative of Example 1. In the adsorbent of Example 2, the terminal of the silane coupling agent includes a functional group which bonds to a desired metal ion (specifically, chromium ion). Alternatively, after the silane coupling agent is treated with acid, the functional group which bonds to the desired metal ion (specifically, chromium ion) is provided to the terminal of the silane coupling agent. Specifically, a solid phase was obtained by adding 0.2 g of the adsorbent of Example 1 to an hydrochloric acid aqueous solution (100 cm³) having pH of 1.0 followed by agitation for one hour and filtration. Then, this solid phase was added to an aqueous solution prepared by dissolving 3.8 g of FeCl₃₀.6H₂O into 150 ml of water, followed by agitation for one hour. Then, after the solid phase was obtained by filtration, the adsorbent of Example 2 provided with the functional group which bonds to the desired metal ion, at the terminal of the silane coupling agent, by means of washing with pure water. The functional group has a structure in which the amino group is coordinated with iron.

10 mg of the respective samples of Example 2, Reference Example 1, Comparative Example 1A and Comparative Example 1B were taken, and added to 5 ml of a sodium chromate aqueous solution having concentration of 0.01% followed by agitation for one hour. As a result of the measurement of amounts of adsorption (mg) of the chromate per 1 g of the sodium chromate aqueous solution based on the colorimeter method using an ultraviolet-visible spectrophotometer, the amount of the adsorption of Example 2 was 6.7 mg. On the other hand, no adsorption could be confirmed in Reference Example 1, Comparative Example 1A and Comparative Example 1B.

### Example 3

Example 3 relates to the mask and the adsorbing sheet of the present disclosure. The mask of Example 3 includes the adsorbent of Example 1 to Example 2. The adsorbing sheet of Example 3 is configured by the sheet-shaped member including the adsorbent of Example 1 to Example 2, and the support member which supports the sheet-shaped member.

A schematic view of the mask is shown in FIG. 2A and a schematic sectional view of a main part (adsorbing sheet) of the mask is shown in FIG. 2B, and the main part of the mask of Example 3 includes a structure in which the sheet-shaped adsorbent of Example 1 to Example 2 is sandwiched between a non-woven fabric and a non-woven fabric made of cellulose. In order to make the adsorbent of Example 1 to Example 2 to be sheet-shaped, for example, a method in which an adsorbent/polymer composite is formed by using a binder made of carboxynitro cellulose may be employed. A carbon/polymer composite is made of the adsorbent of Example 1 to Example 2 and the binder, and the binder is made of the carboxynitro cellulose. On the other hand, the adsorbing sheet of Example 3 is made of the sheet-shaped member made of the adsorbent of Example 1 to Example 2 (specifically, adsorbent including the carboxynitro cellulose as polymer (binder)/polymer composite), and the support member (non-woven fabric which acts as the support member sandwiching the sheet-shaped member) supporting the sheet-shaped member. By applying the adsorbent of the present disclosure to the adsorbent of the mask, pollen, for example, is considered to be effectively adsorbed because a protein site of the pollen is adsorbed on the adsorbent.

### Example 4

Example 4 relates to the adsorbent for the water purification (water purifier).

The adsorbent for the water purification of Example 4 is made of Example 1 to Example 2, and is used for, for example, the water purification and for fluid purification in a broader sense. Alternatively, active oxygen species (oxidative stress substance) such as superoxide, hydroxyl radical, hydrogen peroxide and single oxygen can be removed from the water.

A sectional view of the water purifier of Example 4 is shown in FIG. 3. The water purifier of Example 4 is a continueous water purifier, and is the water purifier directly coupled to a faucet in which the water purifier main body is directly connected to a top end of the water faucet. The water purifier of Example 4 includes the water purifier main body 10, a first filling section 12 filled with the adsorbent 11 of Example 1 to Example 2 positioned inside of the water purifier main body 10, and a second filling section 14 filled with cotton 13. Tap water discharged from the water faucet passes from a flow inlet 15 through the adsorbent 11 and the cotton 13 and is discharged from a flow outlet 16 positioned on the water purifier main body 10

As shown in FIG. 4A which is a schematic partial sectional view, the adsorbent 11 of Example 1 to Example 2 may be incorporated in a bottle (so-called PET bottle) 20 having a cap member 30. Specifically, the adsorbent 11 of Example 1 to Example 2 (filtering medium 40) is positioned inside of the cap member 30, and filters 31, 32 are arranged on a liquid flow-in side and a liquid flow-out side of the cap member 30 such that the filtering medium 40 does not flow out. For example, the liquid (water) is purified and washed by drinking or using the liquid or water (drinking water or beauty wash) 21 in the bottle 20 after the passage of the filtering medium 40 positioned inside of the cap member 30. The cap member 30 is ordinarily closed by using a cover not shown in the drawings.

As shown in FIG. 4B which is a schematic sectional view, the adsorbent 11 of Example 1 to Example 2 (filtering medium 40) may be stored in a bag 50 having water permeability, and this bag 50 may be thrown into the liquid or water (drinking water or beauty wash) 21 in the bottle 20. A reference numeral 22 designates a cap closing a mouth of the bottle 20.

As shown in FIG. 5A which is a schematic sectional view, the adsorbent of Example 1 to Example 2 (filtering medium 40) is stored inside of a straw member 60, and filters not shown in the drawings are arranged on a liquid flow-in side and a liquid flow-out side of the straw member such that the adsorbent (filtering medium 40) does not flow out. The liquid (water) is purified and washed by drinking the liquid or water (drinking water) 21 in the bottle 20 after the passage of the adsorbent (filtering medium 40) of Example 1 to Example 2 positioned inside of the straw member 60. A reference numeral 61 designates a cap closing a mouth of the bottle 20.

As shown in FIG. 5B which is a schematic sectional view a part of which is removed, the adsorbent of Example 1 to Example 2 (filtering medium 40) is positioned inside of a spray member 70, and filters not shown I the drawings are arranged on a liquid flow-in side and a liquid flow-out side of the spray member 70 such that the adsorbent (filtering medium 40) does not flow out. For example, the liquid (water) is purified and washed by spraying the liquid or water (drinking water or beauty wash) 21 in the bottle 20 through a spray aperture 70 after the passage of the adsorbent (filtering medium 40) of Example 1 to Example 2 positioned inside of the spray member 70 by pushing a push button 71 positioned on the spray member 70. A reference numeral 73 designates a cap closing a mouth of the bottle 20.

Although the present disclosure has been described based on preferable Examples, the present disclosure shall not be restricted to these Examples, and various modifications may be possible. The configurations and the structures of the mask, the adsorbing sheet and the water purifier described in Examples are exemplification, and suitably changed. Although the values of the specific surface area and the pore size based on the nitrogen BET method and the NLDFT method, and the pertinent range of the pore size distribution have been described with respect to the adsorbent of the present disclosure, the description does not completely deny the possibility that the values of the specific surface area, and the pore size distribution get out of the above range. That is, the above pertinent range is an especially preferable range for obtaining the effects of the present disclosure, and if the effects of the present disclosure can be obtained, the values of the specific surface area and the like may be out of the range in some degree.

### REFERENCE SIGNS LIST

10 water purifier main part
11 adsorbent
12 first filling section
13 cotton
14 second filling section
15 flow inlet
16 flow outlet
20 bottle
21 liquid or water (drinking water or beauty wash)
22, 61, 73 cap
30 cap member
31, 32 filter
40 adsorbent (filtering medium)
50 bag
60 straw member
70 spray member
71 push button
72 spray aperture

1-9. (canceled)

10. An absorbent comprising:
silica of which a raw material is a material originating from a plant which includes silicon; and
a silane coupling agent which modifies a surface of the silica,
wherein a value of a specific surface area of the silica in accordance with a nitrogen BET method is 10 m²/g or more, and a pore volume of the silica in accordance with a BJH method is 0.1 cm³/g or more.

11. An absorbent comprising:
silica of which a raw material is a material originating from a plant which includes silicon; and
a silane coupling agent which modifies a surface of the silica,
wherein a value of a specific surface area of the silica in accordance with a nitrogen BET method is 10 m²/g or more, and, in pore size distribution of the silica obtained by using a non-localized density functional theory method, a total of volumes of pores each having a pore size ranging from 1 nm to 25 nm is 0.1 cm³/g or more, and a ratio of a total of volumes of pores each having a pore size ranging from 5 nm to 25 nm to the total of volumes of the pores each having the pore size ranging from 1 nm to 25 nm is 0.2 or more.

12. The absorbent according to claim 10, wherein the silane coupling agent is treated with acid, and contains, at a terminal of the silane coupling agent, a functional group which bonds to a specified metal ion.

13. A method of preparing an adsorbent in which a value of a specific surface area of silica in accordance with a nitrogen BET method is 10 m²/g or more, and a pore volume of the silica in accordance with a BJH method is 0.1 cm³/g or more, the method comprising, in the sequence set forth:
obtaining the silica by sintering a material originating from a plant which includes silicon; and
modifying a surface of the silica with a silane coupling agent.

14. A method of preparing an adsorbent in which a value of a specific surface area of silica in accordance with a nitrogen BET method is 10 m²/g or more, and, in pore size distribution of the silica obtained by using a non-localized density functional theory method, a total of volumes of pores each having a pore size ranging from 1 nm to 25 nm is 0.1 cm³/g or more, and a ratio of a total of volumes of pores each having a pore size ranging from 5 nm to 25 nm to the total of volumes of the pores each having the pore size ranging from 1 nm to 25 nm is 0.2 or more, the method comprising, in the sequence set forth:
obtaining the silica by sintering a material originating from a plant which includes silicon; and
modifying a surface of the silica with a silane coupling agent.

15. The method of preparing an adsorbent according to claim 13,
wherein, after modifying the surface of the silica with the silane coupling agent, the silane coupling agent is treated with acid, and a terminal of the silane coupling agent is provided with a functional group which bonds to a specified metal ion.

16. An adsorbent for water purification comprising the adsorbent according to claim 10.

17. A mask comprising the adsorbent according to claim 10.

18. An absorbing sheet comprising a sheet-shaped member made of the adsorbent according to claim 10, and a support member supporting the sheet-shaped member.
